(19) United States
(12) Patent Application Publication
(10) Pub. No.: US 2022/0316710 A1
(43) Pub. Date: Oct. 6, 2022

(54) HEATING COOKING APPARATUS

(71) Applicant: SHARP KABUSHIKI KAISHA, Sakai City, Osaka (JP)

(72) Inventor: MASAYUKI IWAMOTO, Sakai City, Osaka (JP)

(21) Appl. No.: 17/630,771

(22) PCT Filed: Jul. 27, 2020
(86) PCT No.: PCT/JP2020/028704

§ 371 Date: Jan. 27, 2022

(30) Foreign Application Priority Data
Jul. 31, 2019 (JP) 2019-141452

(51) Int. Cl. F24C 7/02; F24C 7/06

(52) U.S. Cl. CPC F24C 7/02; F24C 7/06

(57) ABSTRACT

A heating cooking apparatus (100) includes a heating cooking chamber (100A), a microwave supply unit (15), and a pull-out body (2). The microwave supply unit (15) includes a microwave generation unit (151) configured to generate microwaves, a radiation port (15C) for radiating the microwaves into the heating cooking chamber (100A), and a waveguide (152) positioned below the heating cooking chamber (100A) and configured to guide the microwaves from the microwave generation unit (151) to the radiation port (15C). The pull-out body (2) includes a pull-out main body on which the object (H) to be heated is placed, and a support member (25) positioned below the heating cooking chamber (100A) and configured to support the pull-out main body. The support member (25) extends in a first direction (D1). The support member (25) and the waveguide (152) are positioned at different positions in a second direction (D2) intersecting the first direction (D1) and a vertical direction.

### TECHNICAL FIELD

The present invention relates to a heating cooking apparatus.

### BACKGROUND ART

PTL 1 discloses a pull-out heating cooking apparatus. The pull-out heating cooking apparatus disclosed in PTL 1 includes a heating cooking apparatus main body, a pull-out body, and a moving mechanism. The heating cooking apparatus main body includes a heating cooking chamber. The pull-out body can be drawn toward the outside of the heating cooking apparatus main body from a state where the pull-out body is accommodated in the heating cooking chamber. The moving mechanism supports the pull-out body outside of the heating cooking chamber. In addition, the moving mechanism moves the pull-out body.

Heating functions of the pull-out heating cooking apparatus disclosed in PTL 1 include a microwave heating function and a rapid hot air heating function. The microwave heating function is a function of applying microwaves toward an object to be heated. A radiation port for microwaves is formed in a side wall of the heating cooking chamber.

### CITATION LIST

### Patent Literature

PTL 1: JP 2010-133634 A

### SUMMARY OF INVENTION

### Technical Problem

Further, in a pull-out heating cooking apparatus, there has recently been a demand for efficiently irradiating an object to be heated with microwaves while suppressing the size of the heating cooking apparatus.

In light of the above problem, an object of the present invention is to provide a heating cooking apparatus capable of efficiently irradiating an object to be heated with microwaves while suppressing the size of the heating cooking apparatus.

### Solution to Problem

A heating cooking apparatus of the present invention includes a heating cooking chamber, a microwave supply unit, and a pull-out body. The heating cooking chamber accommodates an object to be heated. The microwave supply unit supplies microwaves to the heating cooking chamber. The pull-out body is freely pulled out from the heating cooking chamber in a first direction. The microwave supply unit includes a microwave generation unit that generates the microwaves, a radiation port for radiating the microwaves into the heating cooking chamber, and a waveguide positioned below the heating cooking chamber and configured to guide the microwaves from the microwave generation unit to the radiation port. The pull-out body includes a pull-out main body on which the object to be heated is placed, and a support member positioned below the heating cooking chamber and configured to support the pull-out main body. The support member extends in the first direction. The support member and the waveguide are positioned at different positions in a second direction intersecting the first direction and a vertical direction.

### Advantageous Effects of Invention

According to the pull-out heating cooking apparatus of the present invention, it is possible to efficiently irradiate an object to be heated with microwaves while suppressing the size of the heating cooking apparatus.

### BRIEF DESCRIPTION OF DRAWINGS

FIG. 1 is a perspective view illustrating an appearance of a pull-out heating cooking apparatus according to an embodiment of the present invention.

FIG. 2 is a right side view illustrating the pull-out heating cooking apparatus according to the present embodiment.

FIG. 3 is a top view illustrating the pull-out heating cooking apparatus according to the present embodiment.

FIG. 4 is a perspective view of a pull-out body according to the present embodiment.

FIG. 5 is a bottom view illustrating the pull-out heating cooking apparatus according to the present embodiment.

FIG. 6 is a diagram illustrating a schematic cross section of a heating chamber according to the present embodiment.

FIG. 7 is a diagram illustrating a schematic cross section of the heating chamber according to the present embodiment.

FIG. 8 is a block diagram illustrating a configuration of the pull-out heating cooking apparatus according to the present embodiment.

FIG. 9 is a diagram illustrating an appearance of a cabinet in which the pull-out heating cooking apparatus according to the present embodiment is built.

### DESCRIPTION OF EMBODIMENTS

Hereinafter, an embodiment of a pull-out heating cooking apparatus according to the present invention will be described with reference to the drawings. In the drawings, the same or equivalent components are denoted by the same reference signs and description thereof will not be repeated.

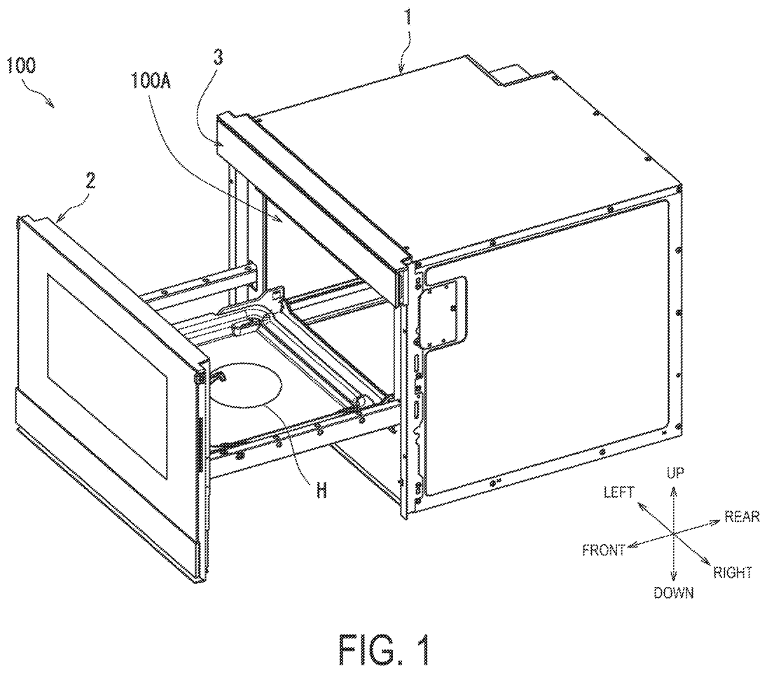

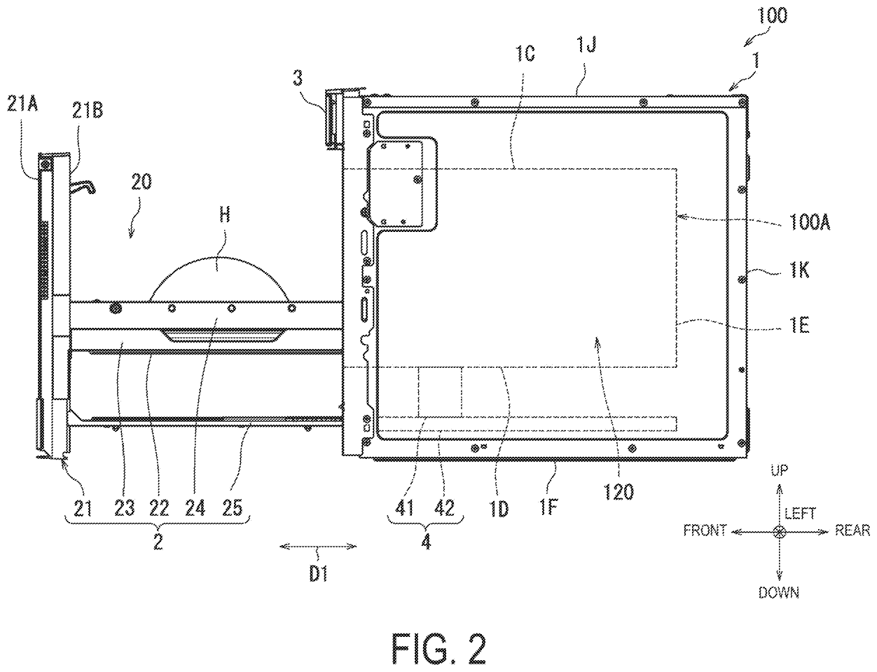

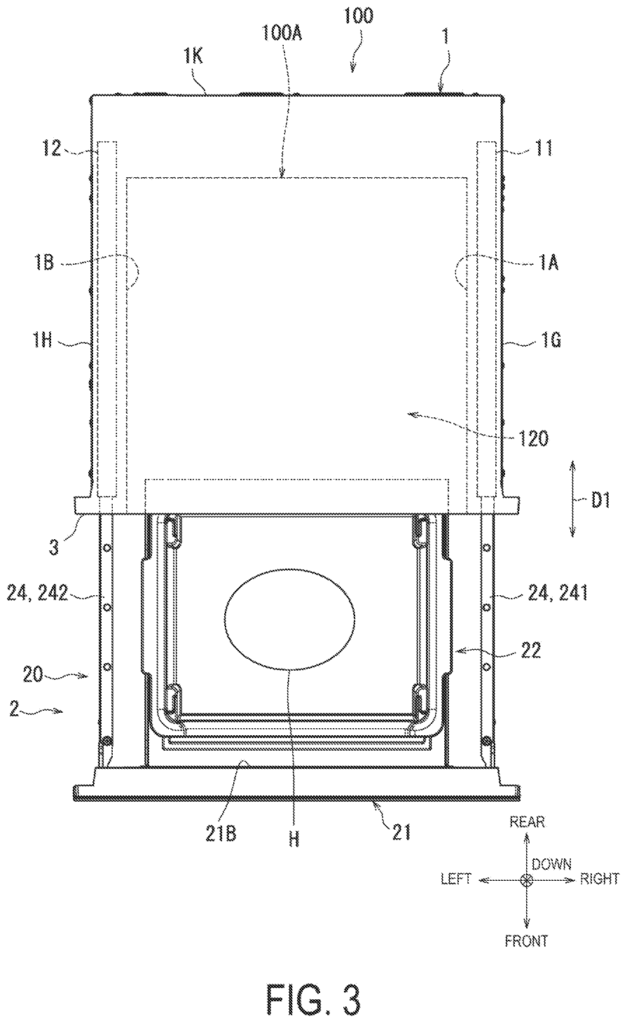

A pull-out heating cooking apparatus 100 according to the present embodiment will be described with reference to FIG. 1 to FIG. 3. FIG. 1 is a perspective view illustrating an appearance of the pull-out heating cooking apparatus 100 according to the present embodiment. FIG. 2 is a right side view illustrating the pull-out heating cooking apparatus 100 according to the present embodiment. FIG. 3 is a top view illustrating the pull-out heating cooking apparatus 100 according to the present embodiment. More specifically, FIG. 1 to FIG. 3 illustrate the pull-out heating cooking apparatus 100 in a state where a pull-out body 2 is pulled out. Further, FIG. 1 illustrates the appearance of the pull-out heating cooking apparatus 100 when viewed from above obliquely from the right. The pull-out heating cooking apparatus 100 is one example of a heating cooking apparatus.

The pull-out heating cooking apparatus 100 heats and cooks an object H to be heated. The object H to be heated is, for example, a food product. As illustrated in FIG. 1, the pull-out heating cooking apparatus 100 includes a heating chamber 1, the pull-out body 2, and an operation panel 3.

In the present embodiment, a side on which the operation panel 3 of the pull-out heating cooking apparatus 100 is disposed is defined as a front side of the pull-out heating cooking apparatus 100, and a side opposite to the front side is defined as a rear side of the pull-out heating cooking apparatus 100. Further, a right side of the pull-out heating cooking apparatus 100 when the pull-out heating cooking apparatus 100 is viewed from the front side is defined as a right side, and a side opposite to the right side is defined as a left side of the pull-out heating cooking apparatus 100. Further, in a direction orthogonal to a front-rear direction and a left-right direction of the pull-out heating cooking apparatus 100, a side on which the operation panel 3 is disposed is defined as an upper side of the pull-out heating cooking apparatus 100, and a side opposite to the upper side is defined as a lower side of the pull-out heating cooking apparatus 100. Note that these orientations do not limit the orientation of the pull-out heating cooking apparatus according to the present invention when in use.

As illustrated in FIG. 2 and FIG. 3, the heating chamber 1 is a box-like member. Specifically, the heating chamber 1 includes a right outer wall 1G, a left outer wall 1H, a top outer wall 1J, a bottom outer wall 1F, and a back outer wall 1K. The heating chamber 1 also includes a heating cooking chamber 100A therein.

The heating cooking chamber 100A includes an accommodation space 120 that accommodates the object H to be heated. The accommodation space 120 is a space that can accommodate the object to be heated H and has a predetermined volume.

Specifically, the heating cooking chamber 100A includes a right wall 1A, a left wall 1B, a top wall 1C, a bottom wall 1D, and a back wall 1E. The shape of the heating cooking chamber 100A is, for example, a substantially rectangular parallelepiped shape. Materials of the right wall 1A, the left wall 1B, the top wall 1C, the bottom wall 1D, and the back wall 1E are, for example, a metal. The front side of the heating cooking chamber 100A is opened for allowing the object to be heated H to be inserted and removed.

The heating chamber 1 further includes a space between the bottom wall 1D and the bottom outer wall 1F. The heating chamber 1 further includes a space between the right wall 1A and the right outer wall 1G. The heating chamber 1 further includes a space between the left wall 1B and the left outer wall 1H. The heating chamber 1 further includes a space between the top wall 1C and the top outer wall 1J. The heating chamber 1 further includes a space between the back wall 1E and the back outer wall 1K.

The operation panel 3 includes an operation unit and a display portion. The operation unit receives an operation from a user. The operation unit includes various types of keys. The display portion displays various pieces of information. The display portion includes a liquid crystal panel. The operation panel 3 is located on an upper portion of a front face of the heating chamber 1.

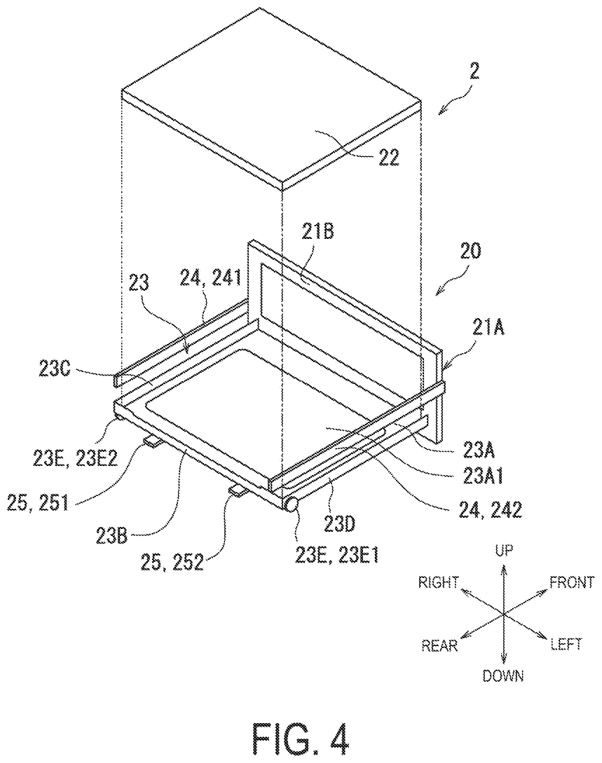

Next, the pull-out body 2 according to the present embodiment will be described with reference to FIG. 1 to FIG. 4. FIG. 4 is a perspective view of the pull-out body 2 according to the present embodiment. As illustrated in FIG. 2 and FIG. 3, the pull-out body 2 is freely pulled out from the heating cooking chamber 100A in a first direction D1. The first direction D1 is a direction parallel to the front-rear direction. More specifically, the pull-out body 2 can be pulled out and pulled in with respect to the heating chamber 1. Specifically, the pull-out body 2 includes a pull-out main body 20. The object H to be heated is placed on the pull-out main body 20. Specifically, the pull-out main body 20 includes a door portion 21, a placing portion 22, and a support portion 23.

The object H to be heated can be placed on the placing portion 22. The placing portion 22 is, for example, a plate-like member made of a ceramic, glass, or a synthetic resin, and is preferably a plate-like member made of a ceramic or glass. As a result, the placing portion 22 transmits microwaves. The placing portion 22 is a transparent or translucent portion. The translucent portion includes a colored transparent portion.

As illustrated in FIG. 2 to FIG. 4, the door portion 21 can open and close an opening on the front side of the heating cooking chamber 100A. The door portion 21 is a substantially rectangular plate-like member. The door portion 21 includes a front face 21A and a rear face 21B. The door portion 21 opens the opening on the front side of the heating cooking chamber 100A in a state where the pull-out body 2 is pulled out of the heating cooking chamber 100A. The door portion 21 closes the opening on the front side of the heating cooking chamber 100A in a state where the pull-out body 2 is pulled into the heating cooking chamber 100A. Meanwhile, in a state where the pull-out body 2 is pushed into the heating cooking chamber 100A, a distance between the top wall 1C and the bottom wall 1D is shorter than a distance between the back wall 1E and the rear face 21B.

The support portion 23 is fixed to the rear face 21B of the door portion 21, and supports a peripheral portion of the placing portion 22 such that the placing portion 22 is held in a horizontal state. Specifically, the support portion 23 includes a base plate portion 23A, a back plate portion 23B, a right plate portion 23C, a left plate portion 23D, and a pair of rollers 23E.

The base plate portion 23A includes a rectangular opening 23A1. The rectangular opening 23A1 is positioned at a substantially center portion of the base plate portion 23A.

The back plate portion 23B, the right plate portion 23C, and the left plate portion 23D are erected upward from the peripheral portion of the base plate portion 23A. The placing portion 22 is fitted between the door portion 21, the back plate portion 23B, the right plate portion 23C, and the left plate portion 23D. In addition, the peripheral portion of the placing portion 22 is fixed to an upper face of the peripheral portion of the base plate portion 23A.

The pair of rollers 23E rotate as the pull-out body 2 moves. Specifically, the pair of rollers 23E include a right roller 23E1 and a left roller 23E2. In addition, the right roller 23E1 is attached to a rear end of the right plate portion 23C. The left roller 23E2 is attached to a rear end of the left plate portion 23D.

The placing portion 22 and the support portion 23 are pulled out of the heating cooking chamber 100A to the outside by pulling out the pull-out body 2. The placing portion 22 and the support portion 23 are accommodated in the heating cooking chamber 100A in a state where the pull-out body 2 is pulled in. As described above, the placing portion 22 is transparent or translucent, and thus a user or the like can visually recognize an object present below the placing portion 22. As a result, the user or the like can easily clean the bottom wall 1D when the bottom wall 1D of the heating cooking chamber 100A is dirty. In addition, an object H to be heated that has fallen onto the bottom wall 1D can be removed before it gets charred.

The pull-out body 2 further includes a pair of slide members 24 and a support member 25 in addition to the pull-out main body 20.

The pair of slide members 24 regulate the movement direction of the pull-out body 2 in the front-rear direction. The pair of slide members 24 are fixed to the rear face 21B of the door portion 21.

Specifically, the pair of slide members 24 includes a right slide member 241 and a left slide member 242. Each of the right slide member 241 and the left slide member 242 is, for example, a member having the front-rear direction as a longitudinal direction. The right slide member 241 and the left slide member 242 oppose each other in the left-right direction. One end portion of the right slide member 241 is attached to a right edge portion of the rear face 21B of the door portion 21. One end portion of the left slide member 242 is attached to a left edge portion of the rear face 21B of the door portion 21.

On the other hand, as illustrated in FIG. 3, the heating chamber 1 further includes a right slide rail 11 and a left slide rail 12. The right slide rail 11 is fixed in a space between the right wall 1A and the right outer wall 1G. The left slide rail 12 is fixed in a space between the left wall 1B and the left outer wall 1H. Each of the right slide rail 11 and the left slide rail 12 is a member having the front-rear direction as a longitudinal direction. The right slide member 241 is supported to be slidable along the right slide rail 11. The left slide member 242 is supported to be slidable along the left slide rail 12.

The support member 25 supports the pull-out main body 20. More specifically, the movement direction of the pull-out main body 20 is regulated so as to be parallel to the first direction D1. The support member 25 extends in the first direction D1. Specifically, the support member 25 is a plate-like member having the front-rear direction as a longitudinal direction. More specifically, the support member 25 includes a first member 251 extending in the first direction D1 and a second member 252 extending in the first direction D1.

The support member 25 is positioned below the heating cooking chamber 100A. The first member 251 and the second member 252 oppose each other in the left-right direction. More specifically, one end portion of the first member 251 is attached on the right side of the rear face 21B of the door portion 21 in the left-right direction and below the placing portion 22. One end portion of the second member 252 is attached on the left side of the rear face 21B of the door portion 21 in the left-right direction and below the placing portion 22. The first member 251 includes a rack portion. The rack portion includes a plurality of teeth.

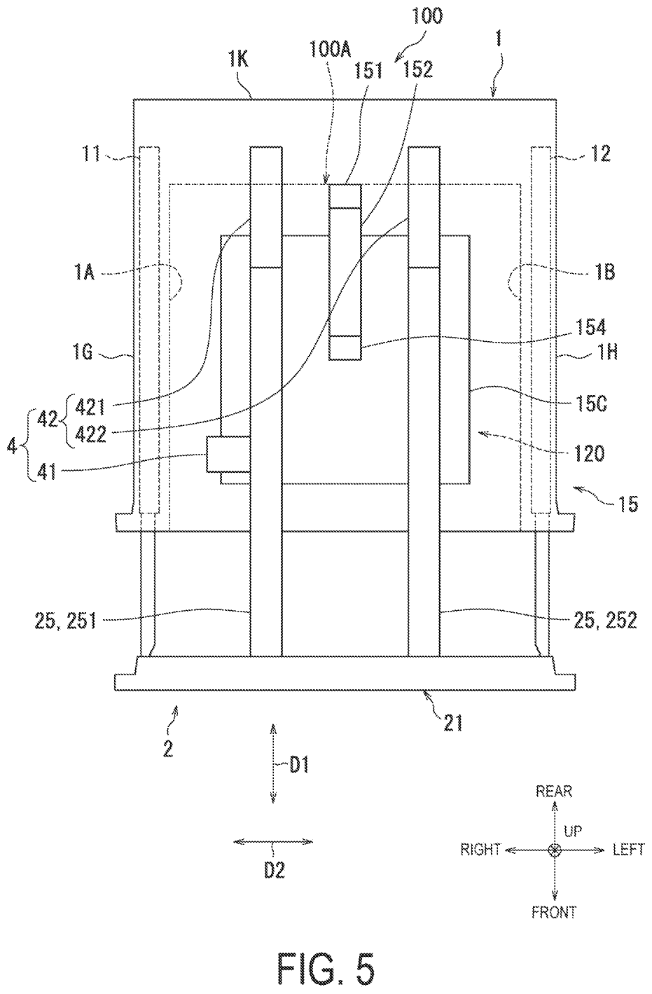

Next, a drive mechanism 4 according to the present embodiment will be described with reference to FIG. 2 to FIG. 5. FIG. 5 is a bottom view illustrating the pull-out heating cooking apparatus 100 according to the present embodiment. As illustrated in FIG. 2, the heating chamber 1 further includes the drive mechanism 4. The drive mechanism 4 drives the support member 25. Specifically, as illustrated in FIG. 5, the drive mechanism 4 drives the first member 251.

Specifically, the drive mechanism 4 further includes a drive motor 41, a pinion, and a drive rail 42. The drive rail 42 further includes a right drive rail 421 and a left drive rail 422. Each of the right drive rail 421 and the left drive rail 422 is fixed in a space between the bottom wall 1D and the bottom outer wall 1F. Each of the right drive rail 421 and the left drive rail 422 is a member having the front-rear direction as a longitudinal direction. The first member 251 is supported to be slidable along the right drive rail 421. The second member 252 is supported to be slidable along the left drive rail 422.

The drive motor 41 is attached to the heating cooking chamber 100A. Specifically, the drive motor 41 is accommodated in a space between the bottom wall 1D and the bottom outer wall 1F. The pinion is attached to a tip end portion of the drive motor 41. The pinion engages with the rack portion of the first member 251. Further, the first member 251 moves in the front-rear direction and the second member 252 moves in the front-rear direction when the pinion rotates. As a result, the pull-out body 2 is in an open state or a closed state.

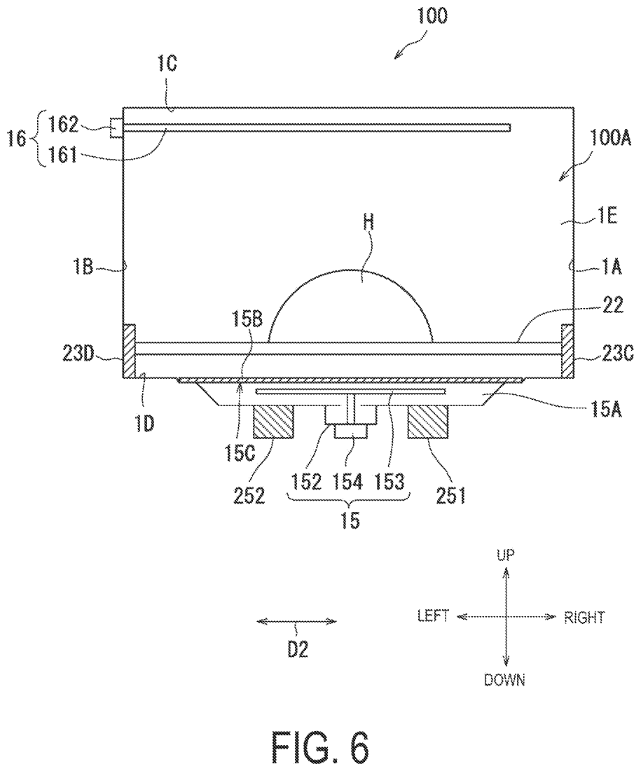

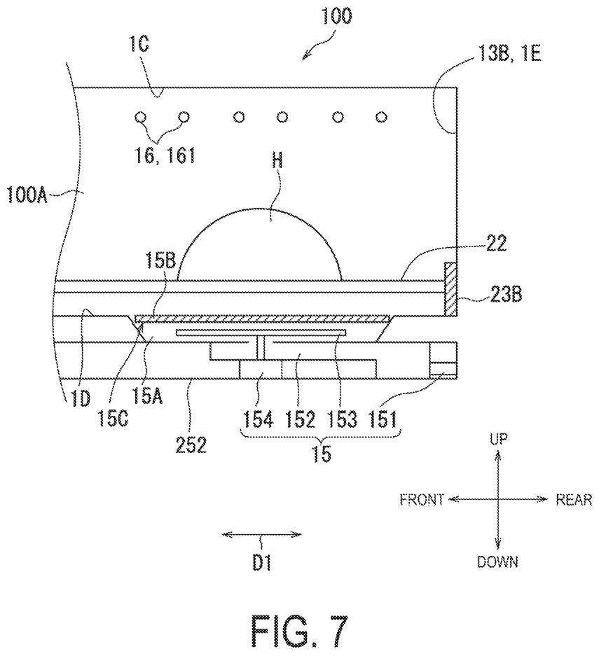

Next, the heating chamber 1 according to the present embodiment will be further described with reference to FIG. 1 to FIG. 7. FIG. 6 and FIG. 7 are diagrams illustrating a schematic cross section of the heating chamber 1 according to the present embodiment. More specifically, FIG. 6 illustrates a cross section of the heating chamber 1 taken along a plane orthogonal to the front-rear direction. FIG. 7 illustrates a cross section of the heating chamber 1 taken along a plane orthogonal to the left-right direction.

As illustrated in FIG. 6 and FIG. 7, the pull-out heating cooking apparatus 100 further includes a microwave supply unit 15 and a partitioning member 15B. The microwave supply unit 15 supplies microwaves to the heating cooking chamber 100A.

The microwave supply unit 15 is positioned outside of the heating cooking chamber 100A via the bottom wall 1D. The microwave supply unit 15 includes a radiation chamber 15A, a magnetron 151, a waveguide 152, a rotary antenna 153, and an antenna motor 154. The magnetron 151 generates microwaves. The magnetron 151 is an example of a microwave generation unit.

The radiation chamber 15A includes a radiation port 15C for radiating microwaves into the heating cooking chamber 100A (see FIG. 5). The shape of the radiation port 15C is, for example, a square shape. In addition, the radiation port 15C is positioned below the heating cooking chamber 100A. Specifically, the radiation port 15C is positioned at a substantially center portion of the bottom wall 1D. The rotary antenna 153 is accommodated in the radiation chamber 15A. The antenna motor 154 drives the rotary antenna 153. The rotary antenna 153 agitates microwaves and supplies the microwaves to the heating cooking chamber 100A through the radiation port 15C.

The waveguide 152 guides microwaves from the magnetron 151 to the radiation port 15C. In addition, the waveguide 152 is positioned below the heating cooking chamber 100A. The support member 25 and the waveguide 152 are positioned at different positions in the second direction D2. The second direction D2 intersects the first direction D1 and the vertical direction. Specifically, the support member 25 and the waveguide 152 are positioned at different positions when viewed from the vertical direction. Preferably, the second direction D2 is parallel to the left-right direction.

As described above, because the support member 25 and the waveguide 152 are positioned at different positions in the second direction D2, the size of the pull-out heating cooking apparatus 100 can be suppressed in the vertical direction. Since the size of the pull-out heating cooking apparatus 100 can be suppressed in the vertical direction, the microwave supply unit 15 can be disposed below the heating cooking chamber 100A. As a result, the object H to be heated can be irradiated with microwaves generated by the microwave supply unit 15 at a short distance. Thus, the object H to be heated can be efficiently heated.

The waveguide 152 extends in the first direction D1. Thus, the size of the space in which the support member 25 is disposed can be increased in the second direction D2. As a result, a larger support member 25 can be disposed. Thus, the support member 25 can have sufficient strength.

Further, the drive mechanism 4, the support member 25, and the waveguide 152 are positioned at different positions in the second direction D2. As a result, the size of the pull-out heating cooking apparatus 100 can be suppressed in the vertical direction. Thus, the pull-out body 2 can be driven by the drive mechanism 4 while the size of the pull-out heating cooking apparatus 100 is suppressed.

More specifically, the waveguide 152 is positioned between the first member 251 and the second member 252 in the second direction D2. As a result, the first member 251 and the second member 252 can support the pull-out main body 20 more stably.

The partitioning member 15B covers the radiation port 15C. The partitioning member 15B need only have a shape that can cover the radiation port 15C. The partitioning member 15B is preferably a plate-like member. Further, the shape of the partitioning member 15B is, for example, a square shape when viewed from the vertical direction.

The material of the partitioning member 15B includes a ceramic or glass. As a result, because the material of the partitioning member 15B includes a ceramic or glass, the partitioning member 15B transmits microwaves. On the other hand, the material of each of the radiation chamber 15A and the waveguide 152 includes a metal.

The pull-out heating cooking apparatus 100 further includes a grill unit 16. Specifically, the grill unit 16 includes a heater 161 and an energization unit 162. The heater 161 is positioned in the heating cooking chamber 100A and heats the object H to be heated. Specifically, the heater 161 is positioned at an upper portion in the heating cooking chamber 100A. The heater 161 has substantially a U shape when viewed from the vertical direction. In the present embodiment, three grill units 16 are disposed. The heater 161 is, for example, a sheathed heater. The energization unit 162 is positioned outside of the left wall 1B. The energization unit 162 energizes the heater 161. The energized heater 161 generates heat.

According to the pull-out heating cooking apparatus 100 of the present invention, the heater 161 is provided in an upper portion of the heating cooking chamber 100A, and the radiation port 15C of the microwave supply unit 15 is provided below the heating cooking chamber 100A. Thus, the heater 161 does not inhibit the object H to be heated from being irradiated with microwaves and conducts heat generated by the heater 161 to the upper face of the object H to be heated, and thus the upper face of the object H to be heated can be efficiently heated.

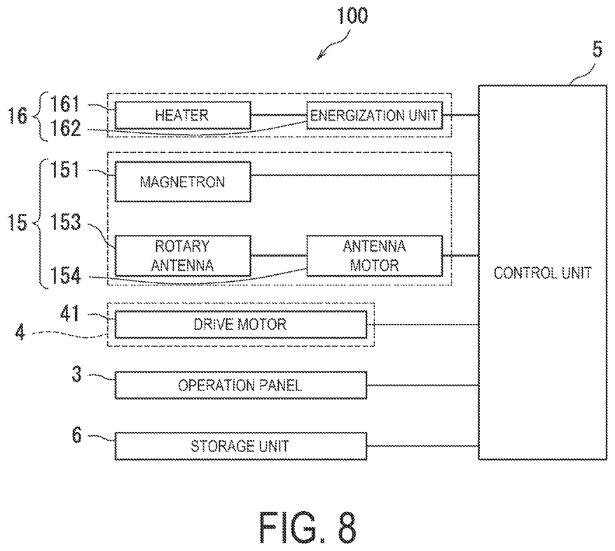

A configuration of the pull-out heating cooking apparatus 100 will be described in detail with reference to FIG. 8. FIG. 8 is a block diagram illustrating a configuration of the pull-out heating cooking apparatus 100 according to the present embodiment.

In the present embodiment, the pull-out heating cooking apparatus 100 has a “microwave heating mode” and a “grill heating mode” as heating cooking modes. The “microwave heating mode” is mainly a mode in which the object H to be heated is heated and cooked by radiating microwaves into the heating cooking chamber 100A. The “grill heating mode” is mainly a mode in which the object H to be heated is heated and cooked by conducting heat generated by the heater 161 to the object H to be heated.

As illustrated in FIG. 8, the pull-out heating cooking apparatus 100 further includes a storage unit 6 and a control unit 5. The storage unit 6 includes a random access memory (RAM) and a read only memory (ROM). The storage unit 6 stores control programs used for controlling operations of each part of the pull-out heating cooking apparatus 100. The storage unit 6 stores setting information input when the operation panel 3 is operated.

The control unit 5 is a hardware circuit that includes a processor such as a central processing unit (CPU). The control unit 5 executes a control program stored in the storage unit 6. The control unit 5 controls the magnetron 151, the antenna motor 154, the energization unit 162, the drive motor 41, the operation panel 3, and the storage unit 6 by executing control programs stored in the storage unit 6.

More specifically, the control unit 5 controls the driving of the microwave supply unit 15 and the driving of the grill unit 16. For example, in a case where the “microwave heating mode” is selected, the control unit 5 drives the magnetron 151 and the antenna motor 154. Further, in a case where the “grill heating mode” is selected, the control unit 5 energizes the energization unit 162.

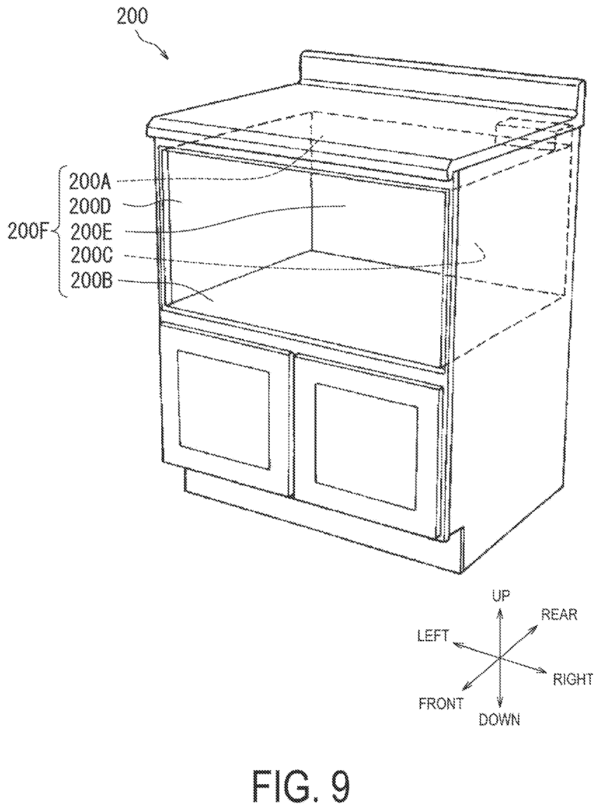

Subsequently, a cabinet 200 to which the pull-out heating cooking apparatus 100 is attached will be described with reference to FIG. 9. FIG. 9 is a diagram illustrating an appearance of the cabinet 200 to which the pull-out heating cooking apparatus 100 according to the present embodiment is attached.

The pull-out heating cooking apparatus 100 is installed in the cabinet 200 in built-in manner. As illustrated in FIG. 9, the cabinet 200 includes an upper wall 200A, a lower wall 200B, a right wall 200C, a left wall 200D, and a rear wall 200E. The upper wall 200A, the lower wall 200B, the right wall 200C, the left wall 200D, and the rear wall 200E form an accommodation portion 200F. The accommodation portion 200F is a rectangular parallelepiped space in which the pull-out heating cooking apparatus 100 is attached.

An embodiment of the present invention has been described above with reference to the drawings. However, the present invention is not limited to the embodiment described above, and the present invention can be implemented in various modes without departing from the gist of the disclosure. The drawings primarily schematically illustrate each of the constituent elements for the sake of easier understanding, and the thickness, length, quantity, and the like of each of the illustrated constituent elements are different from the actual thickness, length, quantity, and the like by reason of creation of the drawings. The material, shape, dimensions, and the like of each of the constituent elements illustrated in the embodiment described above are merely exemplary and are not particularly limiting, and various modifications can be made within the scope not departing from the effects of the present invention in essence.

(1) As described with reference to FIG. 1 to FIG. 9, the support member 25 includes the first member 251 and the second member 252, but the present invention is not limited thereto. For example, the support member 25 may be a single member or may be three or more members.

(2) As described with reference to FIG. 1 to FIG. 9, the waveguide 152 is positioned between the first member 251 and the second member 252 in the second direction D2, but the present invention is not limited thereto. For example, when the support member 25 is a single member, the support member 25 may be positioned on the right side and the waveguide 152 may be positioned on the left side when viewed from the vertical direction. In addition, the support member 25 may be positioned on the left side and the waveguide 152 may be positioned on the right side when viewed from the vertical direction.

(3) As described with reference to FIG. 1 to FIG. 9, the drive mechanism 4 includes a single drive motor 41, but the present invention is not limited thereto. For example, the drive mechanism 4 may include two drive motors 41. The two drive motors 41 may drive the first member 251 and the second member 252.

(4) As described with reference to FIG. 1 to FIG. 9, the pull-out heating cooking apparatus 100 may further include an air sending unit that supplies hot air to the heating cooking chamber 100A.

(5) As described with reference to FIG. 1 to FIG. 9, the pull-out heating cooking apparatus 100 includes the grill unit 16, but the present invention is not limited thereto. The pull-out heating cooking apparatus 100 may not include the grill unit 16.

(6) As described with reference to FIG. 1 to FIG. 9, the placing portion 22 is fixed onto the base plate portion 23A of the support portion 23, but the present invention is not limited thereto. For example, the placing portion 22 may be detachably placed on the support portion 23, or may be placed on the partitioning member 15B.

### Industrial Applicability

The present invention is useful in the field of a heating cooking apparatus, for example.

### REFERENCE SIGNS LIST

1 Heating chamber
2 Pull-out body
4 Drive mechanism
15 Microwave supply unit
15B Partitioning member
15C Radiation port
20 Pull-out main body
21 Door portion
22 Placing portion
23 Support portion
25 Support member
100 Pull-out heating cooking apparatus
100A Heating cooking chamber

1. A heating cooking apparatus comprising:
a heating cooking chamber configured to accommodate an object to be heated;
a microwave supply unit configured to supply microwaves to the heating cooking chamber; and
a pull-out body configured to be freely pulled out from the heating cooking chamber in a first direction,
wherein the microwave supply unit includes
a microwave generation unit configured to generate the microwaves,
a radiation port for radiating the microwaves into the heating cooking chamber, and
a waveguide positioned below the heating cooking chamber and configured to guide the microwaves from the microwave generation unit to the radiation port,
the pull-out body includes
a pull-out main body on which the object to be heated is placed, and
a support member positioned below the heating cooking chamber and configured to support the pull-out main body,
the support member extends in the first direction, and
the support member and the waveguide are positioned at different positions in a second direction intersecting the first direction and a vertical direction.

2. The heating cooking apparatus according to claim 1,
wherein the waveguide extends in the first direction.

3. The heating cooking apparatus according to claim 1, further comprising:
a drive mechanism configured to drive the support member,
wherein the drive mechanism, the support member, and the waveguide are positioned at different positions in the second direction.

4. The heating cooking apparatus according to claim 1,
wherein the support member includes a first member extending in the first direction, and a second member extending in the first direction, and
the waveguide is positioned between the first member and the second member in the second direction.

5. The heating cooking apparatus according to claim 1,
wherein the pull-out main body includes a placing portion on which the object to be heated is placed,
the placing portion is able to be pulled out from the heating cooking chamber and is able to be accommodated in the heating cooking chamber, and
the support member is positioned below the placing portion.

6. The heating cooking apparatus according to claim 1, further comprising:
a heater positioned in the heating cooking chamber and configured to heat the object to be heated,
wherein the heater is positioned at an upper portion of the heating cooking chamber.
